(19) United States
(12) Patent Application Publication
(10) Pub. No.: US 2013/0037435 A1
(43) Pub. Date: Feb. 14, 2013

(54) PACKAGE WITH INTEGRAL MARKERS FOR CONTAINERS

(71) Applicant: Marc ST-LAURENT, Montreal (CA)

(72) Inventor: Marc ST-LAURENT, Montreal (CA)

(21) Appl. No.: 13/584,351

(22) Filed: Aug. 13, 2012

Related U.S. Application Data
(60) Provisional application No. 61/522,437, filed on Aug. 11, 2011.

(51) Int. Cl. B65D 85/00; B65D 5/70; B31B 1/26; B31B 1/25; B31B 1/88; B31B 1/16

(52) U.S. Cl. 206/427; 493/54; 493/74; 493/79; 493/84; 493/59; 206/459.5

(57) ABSTRACT

The present invention relates to a packaging, and more particularly, to a package for a beverage to be consumed by a plurality of consumers, as well as to a package assembly for making the package, and to a method of manufacturing the same. A package is adapted for packaging a beverage to be consumed from a plurality of containers by a plurality of consumers, the package having consumer-identification markers made integral with the package. More particularly, the package is made from a package assembly, including a blank made from a web of packaging material, consumer-identification markers defined in the blank by a detachment delimiter, each marker having a mounting element for mounting each of the consumer-identification markers on one of the containers, in order to associate the container with a given one of said plurality of consumers.

### FIELD OF THE INVENTION

The present invention relates to a packaging. More particularly, the present invention relates to a package for a beverage to be consumed by a plurality of consumers, as well as to a package assembly for making the package, and to a method of manufacturing the same.

### BACKGROUND OF THE INVENTION

It is known in the art that markers may be used for identifying beer bottles during gatherings to be associated with each of the consumers of the beer bottles. Such markers may be provided as a distinct article which is sold for this purpose. However, such articles must be purchased and furnished separately from the beer bottles, and may be lost, etc. Moreover, when gatherings are held in public areas or outdoor areas, consumers may not be equipped with such markers.

Known in the art are beer bottles which are provided with labels adhered to the bottle which may be personalized (by engraving a mark) for identification purposes. In some cases, consumers will mark their beer bottles using a pen or scratching the label of the particular beer. However, such markings have limited visibility (especially in areas of low lighting, etc.).

Known to the Applicant are U.S. Pat. Nos. 8,196,763 B2 (GREENBERG); 6,295,894 B1 (CRAIG); and 4,197,984 (HARTMAN et al.); United States Patent Applications having publication Nos.: 2010/0313767 A1 (KRAMER); 2009/0212954 A1 (ADSTEDT et al.); 2009/0045081 A1 (HAMANN); and International Patent Application having publication No: WO 2007/003212 A1 (BURATO et al.).

Hence, in light of the aforementioned, there is a need for an improved package which, by virtue of its design and components, would be able to overcome some of the above-discussed prior art concerns.

### SUMMARY OF THE INVENTION

The object of the present invention is to provide a package which, by virtue of its design and components, satisfies some of the above-mentioned needs and is thus an improvement over other related packages and/or packaging methods known in the prior art.

In accordance with the present invention, the above mentioned object is achieved, as will be easily understood, by a package for packaging containers such as the one briefly described herein and such as the one exemplified in the accompanying drawings.

According to an aspect of the present invention there is provided a method of manufacturing a package assembly for forming a package for a beverage to be consumed from a plurality of containers by a plurality of consumers. The method comprises the steps of:
a) shaping a blank from a web of packaging material;
b) configuring the blank for assembling the blank into the package;
c) providing detachment delimiters in the blank for defining respective consumer-identification markers (also referred to herein as “markers”), each consumer-identification marker being detachable from the blank along the corresponding detachment delimiter; and
d) providing a mounting element on each of the consumer-identification markers of the blank for mounting each of the consumer-identification markers on one of the containers, in order to associate the container with a given one of said plurality of consumers.

Preferably, the web of step (a) comprises cellulose fiber material. Still preferably, the shaping of step (a) comprises die-cutting the web to form the blank.

The configuring of step (b) preferably comprises drawing fold lines to define panels which can be folded and assembled into said package. The “configuring” of step (b) may include shaping and providing the blank with the necessary components in order to form the package. For example, providing fold lines and/or folding the blank, gluing portions of the blank or applying an adhesive, cutting tags, slits or openings, in order to assemble the blank, etc.

Preferably, the forming of the detachment delimiters in step (c) comprises perforating the blank along the detachment delimiter of each of the consumer-identification markers.

Preferably, the panels defined at step (b) comprise wall portions to form walls of the package when the wall portions are assembled and deployed, lower flaps extending from the wall portions for forming a floor of the package when assembled with the deployed wall portions in order to give the package a box-shape for holding the beverage, and upper flaps extending from the wall portions opposite the lower flaps to form a cover for the package. Each of the consumer-identification markers may be substantially located on one of the upper flaps, preferably along a peripheral edge of one of the upper flaps. The upper flaps comprise inner flaps which are hidden when the package is closed and outer flaps which cover the inner flaps when the package is closed, each of the consumer-identification markers being provided in one of the inner flaps.

Preferably, the above-method further comprises further comprising printing a field on each consumer-identification marker for receiving at consumption of the beverage, personalization information being representative of an associated one of the consumers.

The mounting element provided at step (d) may comprise: perforating a loop in an inner portion of each consumer-identification marker to form a removable center; providing an open loop in each consumer-identification marker; cutting an inner portion of the each consumer-identification marker to form an opening; and/or applying an adhesive on each consumer-identification marker.

According to another aspect of the present invention there is provided a method of manufacturing a package assembly for forming a package for a beverage to be dispensed into a plurality of containers for a plurality of corresponding consumers. The method comprises the steps of:
a) shaping a blank from a web of packaging material;
b) configuring the blank for packaging the beverage;
c) forming detachment perimeters in the blank for defining respective markers, each marker being detachable from the blank along the corresponding detachment perimeter; and
d) providing a mounting mechanism on each of the markers of the blank for mounting each of the markers on one of the containers, in order to associate the container with a given one of said plurality of consumers.

According to another aspect of the present invention there is provided a method of manufacturing a package assembly for providing a package for a plurality of beverage containers. The method comprises the steps of:
a) shaping a blank from a web of packaging material;
b) configuring the blank to be deployed into a package for the beverage containers;
c) forming detachment perimeters in the blank for defining respective consumer-identification markers, each consumer-identification marker being detachable from the blank along the corresponding detachment perimeter; and
d) providing a mounting mechanism on each of the consumer-identification markers of the blank for mounting each of the consumer-identification markers on one of said beverage container, in order to associate the beverage container with a given consumer of said beverage container.

According to yet another aspect of the present invention there is provided a package for a beverage to be consumed from a plurality of containers by a plurality of consumers, the package assembly comprising:
a blank made from a web of packaging material, the blank comprising one or more assembly component for assembling the blank into said package;
consumer-identification markers being provided in the blank, each being defined by a detachment delimiter in order to detach the consumer-identification marker from the blank along said detachment perimeter; and
a mounting element being provided on each of the consumer-identification markers of the blank for mounting each of the consumer-identification markers on one of the containers, in order to associate the container with a given one of said plurality of consumers.

According to yet another aspect of the present invention there is provided a package for a beverage to be consumed from a plurality of containers by a plurality of consumers, the package comprising:
a package component being assembled from a blank of packaging material, the package component packaging the beverage;
consumer-identification markers being provided in the package component, each being defined by a detachment delimiter in order to detach the consumer-identification marker from the package component, along said detachment perimeter; and
a mounting element being provided on each of the consumer-identification markers for mounting each of the consumer-identification markers on one of the containers, in order to associate the container with a given one of said plurality of consumers.

According still to another aspect of the present invention there is provided a method of making a package for a beverage to be consumed from a plurality of containers by a plurality of consumers. The method comprises the steps of:
a) shaping a blank from a web of packaging material;
b) providing the blank with one or more assembly component for assembling the blank into said package;
c) providing detachment delimiters in the blank for defining respective consumer-identification markers, each consumer-identification marker being detachable from the blank along the corresponding detachment delimiter;
d) providing a mounting element on each of the consumer-identification markers of the blank for mounting each of the consumer-identification markers on one of the containers, in order to associate the container with a given one of said plurality of consumers; and
e) assembling the blank into said package by means of the one or more assembly component.

According still to another aspect of the present invention there is provided a method of packaging a beverage to be consumed from a plurality of containers by a plurality of consumers. The method comprises the steps of:

a) providing a package comprising:
a package component being assembled from a blank of packaging material;
consumer-identification markers being provided in the package component, each being defined by a detachment delimiter in order to detach the consumer-identification marker from the package component, along said detachment perimeter; and
a mounting element being provided on each of the consumer-identification markers for mounting each of the consumer-identification markers on one of the containers, in order to associate the container with a given one of said plurality of consumers; and
   b) introducing the beverage in the package component.

The introducing step (b) may include introducing bottled beverage, for example beer bottles or the like. Alternatively, the introducing step (b) may include introducing a bagged beverage, for example wine or the like.

According to another aspect of the present invention there is provided a package for packaging one or more container(s), the package comprising:
a main body, for holding the container(s); and
one or more markers being detachably connected to the main body, each of the markers having a mounting component to mount the marker on one of the containers. It is to be understood that the mounting component may be provided by an opening in the marker, a slit, an adhesive, one or more hook, etc., as will be better understood in light of the following.

According to another aspect of the present invention, there is provided a package for packaging one or more container(s), each container having a neck, the package comprising:
a main body, for holding the container(s); and
one or more markers being formed integrally with the main body, each of the markers being detachable from the main body, each of the markers being provided with an opening shaped and sized to fit about the neck of one of the containers so as to support the marker on the neck of the container.

According to another aspect of the present invention, there is provided a blank for forming a package for one or more container(s), the blank comprising:
a main body portion, for forming a main body of the package, to hold the containers; and
one or more markers being formed integrally with the main body portion, each of the marker detachable from the main body, each of the markers being provided with an opening shaped and sized to fit about the neck of one of the containers so as to support the marker on the neck of the container.

Preferably, the marker(s) in the above-mentioned package and/or blank is delimited from the main body (or main body portion in the case of the blank) by a line of weakness so as to detach from the main body.

In the context of the present invention, the term “package” refers to a material allowing to contain the beverage or to group containers of beverage in a suitable format for transportation, shipping, storing, distributing and/or selling the beverage.

In the context of the present invention, “package assembly” is a partially assembled blank which is intended to form a package. A package assembly may be for example a preassembled collapsed box, which when fully assembled may be filled with a beverage or beverage containers, or a folding carton to be shipped to a packer and which can be assembled into a package. Another example is a sheet of material which group bottles together by the necks of the bottles.

In the context of the present invention, a “detachment delimiter” refers to a line, portion or area in the blank or package with facilitate separation of one of markers from the package. A detachment delimiter may be provided by a “line of weakness” which refers to a line portion or region on the package or blank which facilitates tearing along this line portion or region, when subjected to tension. Accordingly, the “line of weakness” may be provided by a cut-score crease, a line of perforations, a fold line, a line portion being pressed, a slit, a line or portion of material having a weaker composition than the rest of the material forming the package and/or any combination thereof which facilitates detaching the marker from the main body. Another “detachment delimiter” may be provided when the marker is an adhesive (i.e. a “sticker”), such that the detachment delimiter extends along the area delimiting the sticker.

Also in the context of the present invention, it is to be understood that the “blank” from which the package is assembled may be provided by a plurality of components. Also, the blank may be configured to be assembled with other components in order to make the final package.

Preferably, the above-mentioned package, package assembly and/or blank is made of a cellulose fiber material, for example, containerboard, corrugated material, a folding carton, boxboard, paperboard, paper material, cardboard, and/or the like, which may include virgin material, recycled material, molded pulp, etc. and may be multi-layered, laminated, etc. Alternatively, the package and/or blank may include any suitable material for holding the containers (for example, plastic, aluminum, etc).

The main body generally refers to a wrapping or any suitable packaging component for packaging the container(s) or beverage for storage, transportation and/or distribution to consumers. The main body may enclose or partially enclose the container(s) and/or beverage, and/or it may hold or bind a plurality of containers together to form a unit.

By the term “support”, it is meant that the marker sits or rests about the neck, or that it “clings” to the neck to be supported by friction, and/or the like.

According to another aspect, there is provided the above-mentioned package in combination with containers.

According to another aspect of the present invention, there is provided a method for manufacturing the above-mentioned blank.

According to another aspect of the present invention, there is provided a method for manufacturing the above-mentioned package.

According to another aspect of the present invention, there is provided a method for assembling the above-mentioned package from the blank.

The objects, advantages and features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a perspective view of a package, according to an embodiment of the present invention, the package being shown with an upper portion being open.

FIG. 2 is a perspective view of a package, according to another embodiment of the present invention, the package being shown behind a beer bottle with a marker supported thereon, which has been detached from the package.

FIG. 3 is a top plan view of a blank for making the package shown in FIG. 1.

FIG. 4 shows a package assembly in a given step of a method for assembling the package shown in FIG. 1, according to a preferred embodiment of the present invention.

FIG. 5 shows another step of the method shown in FIG. 4.

FIG. 6 shows another step of the method shown in FIG. 5.

FIG. 7 shows another step of the method shown in FIG. 6, wherein the package is assembled.

FIG. 8 is a top perspective view of the package shown in FIG. 7.

FIG. 9 is a perspective view of a package, according to another embodiment of the present invention, the package being shown with an upper portion being open and with a marker having been detached therefrom.

FIG. 10 is another perspective view of the package shown in FIG. 9.

FIG. 11 is a perspective view of a package, according to another embodiment of the present invention.

FIG. 12 is a perspective view of a package, according to yet another embodiment of the present invention.

### DETAILED DESCRIPTION OF PREFERRED EMBODIMENTS OF THE INVENTION

In the following description, the same numerical references refer to similar elements. The embodiments, geometrical configurations, materials mentioned and/or dimensions shown in the figures or described in the present description are preferred embodiments only, given for exemplification purposes only.

In the context of the present invention, the expressions “package”, “packaging”, “box”, “compartment”, “main body”, and any other equivalent expression and/or compound words thereof known in the art will be used interchangeably. The same applies for any other mutually equivalent expressions, such as “perforation”, “line of perforation”, and “perforation line”, for example, as also apparent to a person skilled in the art.

Moreover, although the preferred embodiment of the present invention as illustrated in the accompanying drawings comprises components such as wall portions, upper flaps, lower flaps, handles, perforation lines, etc., and although the preferred embodiment of package and/or blank and corresponding parts (for example: markers, openings, perforations, etc.) thereof consists of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the package and/or blank according to the present invention, as will be briefly explained herein and as can be easily inferred herefrom, by a person skilled in the art, without departing from the scope of the invention.

Furthermore, the order of the steps of the method described herein should not be taken as to limit the scope of the invention, as the sequence of the steps may vary in a number of ways, without affecting the scope or working of the invention, as can also be understood.

Broadly described, there is provided a package for packaging a beverage, having markers which are made integral with the package and which are detachable from the package, in order to provide a disposable marker for each of the consumers of the beverage. Preferably, each of the markers is provided with an opening in order to be placed about the neck of a container, such as a beer bottle, for example. Preferably, the markers are colored with different colors and/or provided with different visual markings in order to be visually distinct.

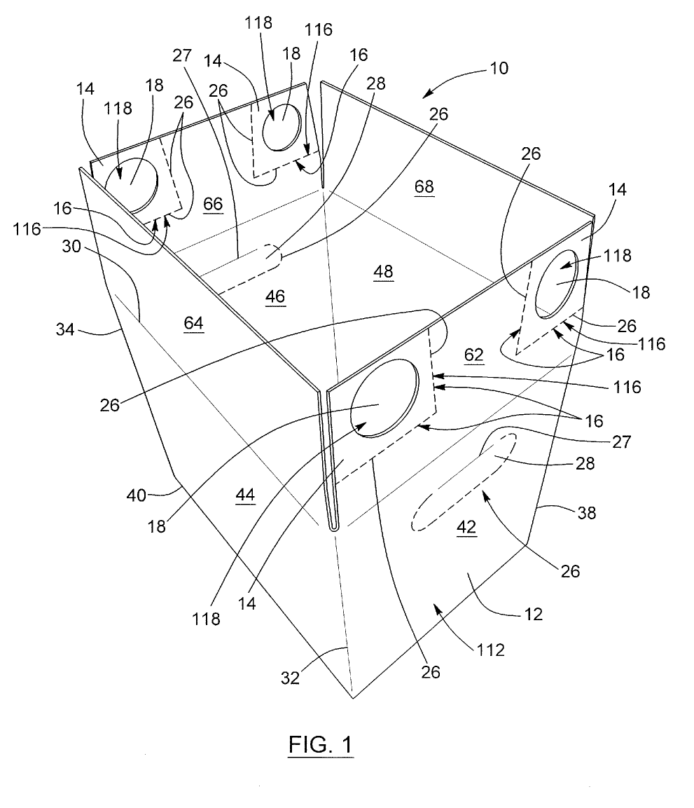

Preferably and as better illustrated in FIGS. 1, 2 and 3, there is provided a package (10) for a beverage to be consumed from a plurality of containers (120) by a plurality of consumers. The package comprises a package component (112) being assembled from a blank (24) of packaging material. The package component (112) may include any suitable component or assembly for packaging the beverage for transportation, storage, distribution, commercialization and/or the like. Consumer-identification markers (14) are provided in the package component (112), each being defined by a detachment delimiter (116) in order to detach the consumer-identification marker from the package component, along said detachment delimiter. A mounting element (118) is provided on each of the consumer-identification markers (24) for mounting each of the consumer-identification markers (24) on one of the containers (120) at consumption (i.e. in any appropriate time close to consumption, before or during consumption of the beverage), in order to associate the container with a given one of said plurality of consumers.

According to embodiments of the present invention, the packaging material may comprise cellulose fiber material, for example, containerboard, corrugated material, a folding carton, boxboard, paperboard, paper material, cardboard, and/or the like, which may include virgin material, recycled material, molded pulp, etc. and may be multi-layered, laminated, etc. Alternatively, the packaging material may include any suitable material for packaging the beverage (for example, plastic, aluminum, etc).

The detachment delimiters and lines of weakness are generally identified by reference numerals 116 and 16, respectively in FIG. 1, however it is to be understood that perforation lines (26) described further below and illustrated in the figures also correspond to detachment delimiters (116) and lines of weakness (16).

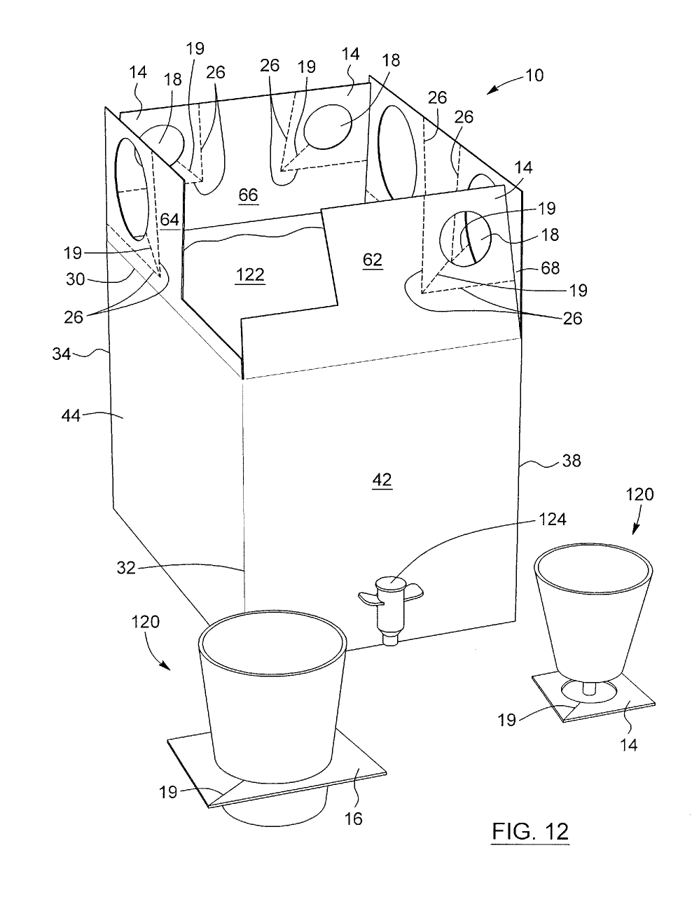

According to embodiments of the present invention, the containers (120) may be provided in the package, each container (120) containing the beverage. Alternatively, the containers (120) or a portion thereof are provided separately. Indeed and for example, the package component (112) may be adapted to package a container (122) filled with the beverage, the package component further comprising a dispenser (124) being in connected to the container (122), in order to dispense the beverage into the plurality of containers (120), as exemplified in FIG. 12 and as will be better described further below.

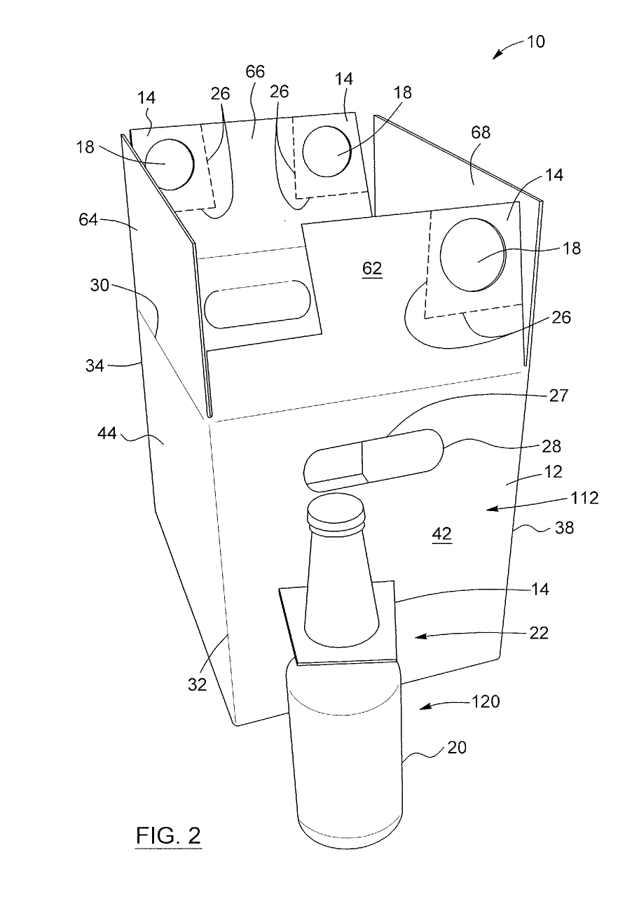

More particularly, with reference to FIGS. 1 and 2, the package (10) of the present invention according to a preferred embodiment comprises: a main body (12) which constitutes the afore-mentioned “package component” (112), made of corrugated containerboard, for holding containers (such as beer bottle (20); and markers (14) being formed integrally with the main body (12), each of the markers (14) being defined by a line of weakness (16) namely, perforations (26) so as to detach from the main body (12), each of the markers (14) being provided with an opening (18) sized and shaped for supporting the marker (14) about the neck (see 22 in FIG. 2) of one of the containers (20 in FIG. 2).

Thus, the package component (112) is adapted to package beverage containers (120) such as bottles (20). According to alternate embodiments, the beverage containers may comprise a can, a disposable glass and/or the like. The package component is preferably adapted to package 2 or more beverage containers. For example, the package component may be adapted to package 4, 6, 12, 18, or 24 beverage bottles. The packaged beverage may be beer, a cooler beverage, wine, liquor, a cocktail beverage, sparkling wine, champagne, juice, a soft drink, water, and/or the like.

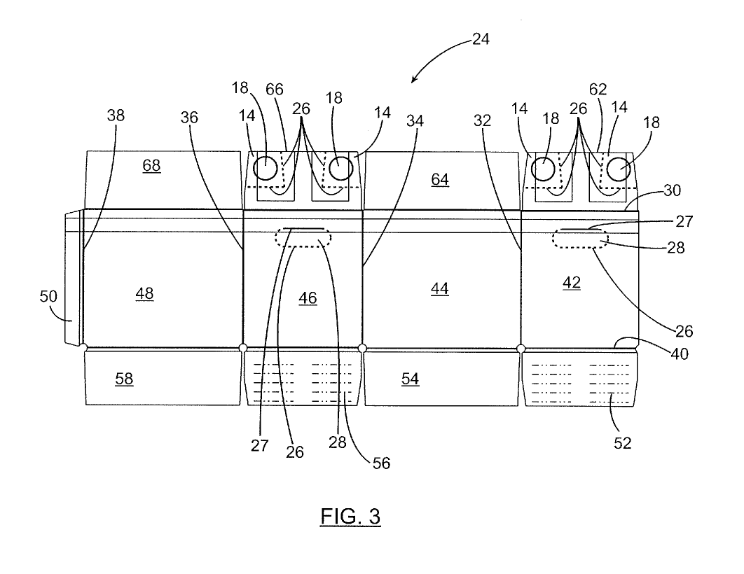

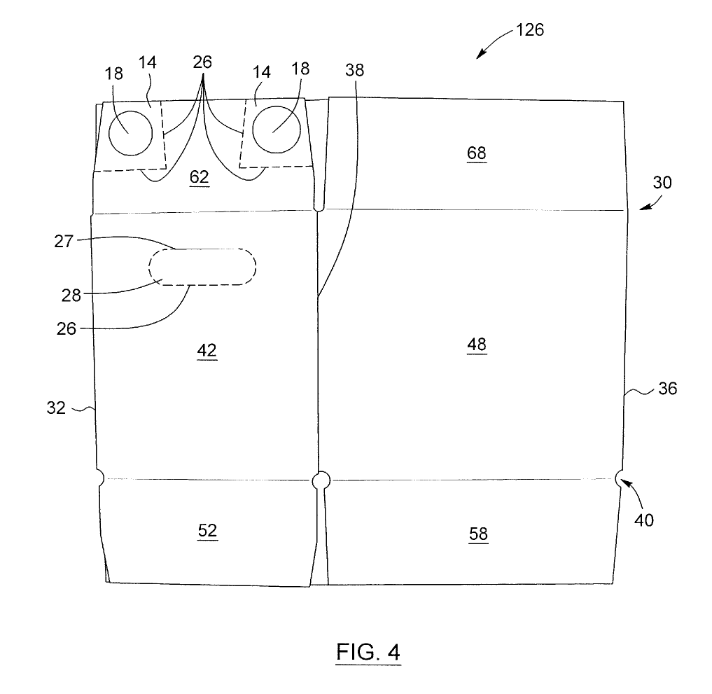

The package component (112) is made from a package assembly (126), as illustrated in FIG. 4, which shows a collapsed package assembly having been pre-assembled and which is operable to form a package. The package assembly (126) comprises a blank (24), as better illustrated in FIG. 3, made from a web of packaging material, which preferably includes a cellulose fiber material. The blank (24) comprises one or more assembly component, such as strip (50), lower flaps (52, 54, 56, 58), as well as fold line(s) (30, 32, 34, 36, 38, 40), for assembling the blank into the package. The package assembly (126) further comprises consumer-identification markers (14) being provided in the blank (24), each being defined by a detachment delimiter (116) (see FIG. 1), such as perforation lines (26), in order to detach the consumer-identification marker (14) from the blank (24) along the detachment delimiter (116). The package assembly (126) further comprises a mounting element (118) (see FIG. 1) such as opening (18), being provided on each of the consumer-identification markers (14) of the blank (24) for mounting each of the consumer-identification markers (14) on one of the containers (120) (see FIG. 2), in order to associate the container (120) with a given one of the consumers.

More particularly, the blank (24) is manufactured by first providing a web of corrugated containerboard. With reference to FIG. 3, the web is die-cut to shape the blank (24) and provide openings (18). Perforation line(s) (26) and fold line(s) (27) are then added in order to define handles (28) and the markers (14). Fold line(s) (30, 32, 34, 36, 38, 40) are also added for example using a press, to define wall portions (42, 44, 46, 48), strip (50), lower flaps (52, 54, 56, 58) and upper flaps (62, 64, 66, 68).

The blank may then be shipped immediately or assembled to form a package assembly (126), such as a collapsed folding carton, as illustrated in FIG. 4. At the time of packing, the collapsed carton is erected and filled with content, such as beer bottles, and closed for transportation, storage or distribution.

More particularly, a collapsed carton (also referred to herein as “collapsed assembly”) is produced as shown in FIG. 4, by joining wall portions (42) and (48), namely by folding the blank along fold line (32) and again along fold line (36). The strip (50), better illustrated in FIG. 3, is then glued under wall portion (42) to form a tubular configuration.

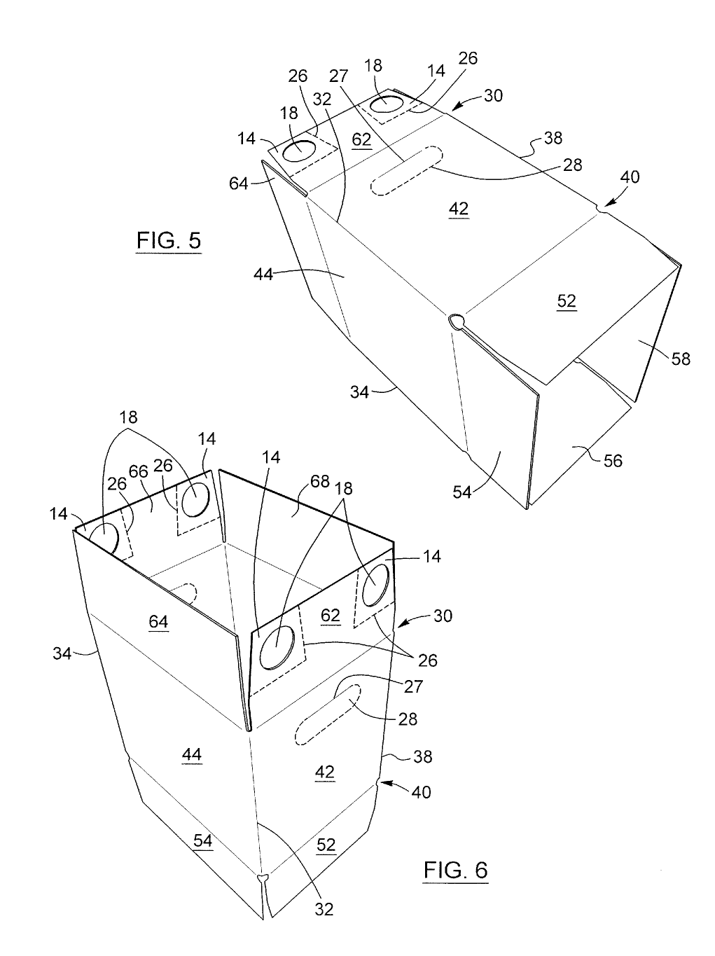

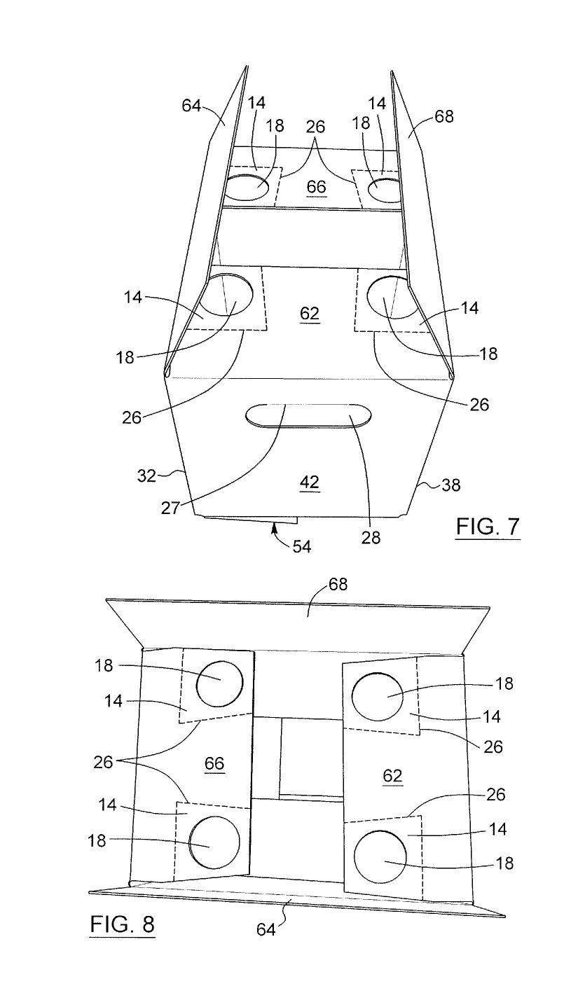

In order to deploy (or “erect”) the package, the collapsed carton is folded along fold lines (34, 38) to form a tubular shape as shown in FIGS. 5 and 6. As illustrated in FIG. 7, the lower flaps (52, 54, 56, 58), better illustrated in FIG. 5, are then folded in about fold line (40) to form a floor. The floor cooperates with the wall members (42, 44, 46, 48), better illustrated in FIG. 5, to form a box compartment for holding containers.

Once the containers are placed in the box compartment, the upper flaps (62, 64, 66, 68) are folded about fold line (30) in order to close the box compartment and complete the packaging process. FIGS. 7 and 8, show the package (10) in a partially closed configuration.

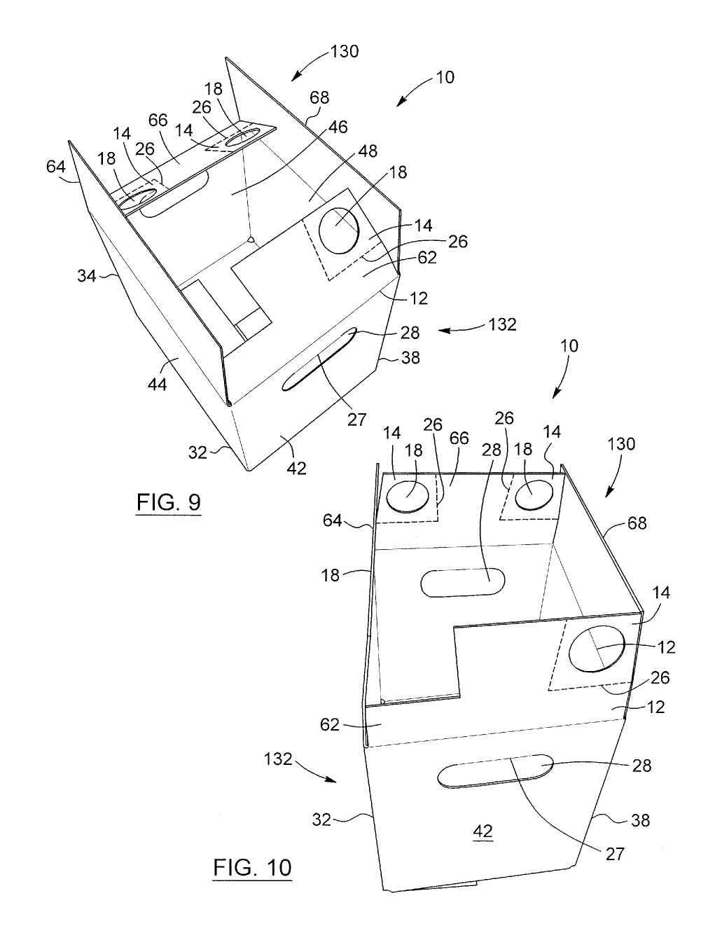

Referring to FIGS. 9 and 10, the package (10) formed by the blank (24) when deployed defines a supporting portion (132) for supporting the beverage and a non-supporting portion (130), and the consumer-identification markers (14) are formed in the non-supporting portion (130). More particularly, the supporting portion (132) is a box for receiving the beverage and the non-supporting portion (130) is a cover for the box. The blank (24) (see FIG. 2) comprises wall portions (42, 44, 46, 48) delimited by fold lines (38, 36, 34, 32) to form walls of the box, as well as lower flaps (58, 56, 54, 52) extending from the wall portions (42, 44, 46, 48) and being delimited from the wall portions by fold line (40) to form a floor of the box. Upper flaps (68, 66, 64, 62) extend from the wall portions (42, 44, 46, 48) opposite the lower flaps (58, 56, 54, 52), and being delimited from the wall portions by fold line (30) to form the cover of the box. The consumer-identification markers (14) are located on peripheral edges of the upper flaps (62, 66).

As better illustrated in FIGS. 7 and 8, the upper flaps comprise inner flaps (62, 66) which are hidden when the package (10) is closed and outer flaps (64, 68) which cover the inner flaps (62, 66) when the package is closed, and wherein the consumer-identification markers (14) are located substantially on the inner flaps (62, 66), so as to hide the markers when the box is closed, such that the general presentation of the package is similar to a conventional package. Still advantageously, the outer flaps (64, 68) substantially cover the box, and therefore when the markers (14) are removed from the package, the outer flaps (64, 68) are still intact and operable to cover the box portion of the package.

Alternatively, the consumer-identification markers are located in a visible portion of the package when the blank is deployed, in order to attract attention to the markers to to distinguish the package from conventional packages.

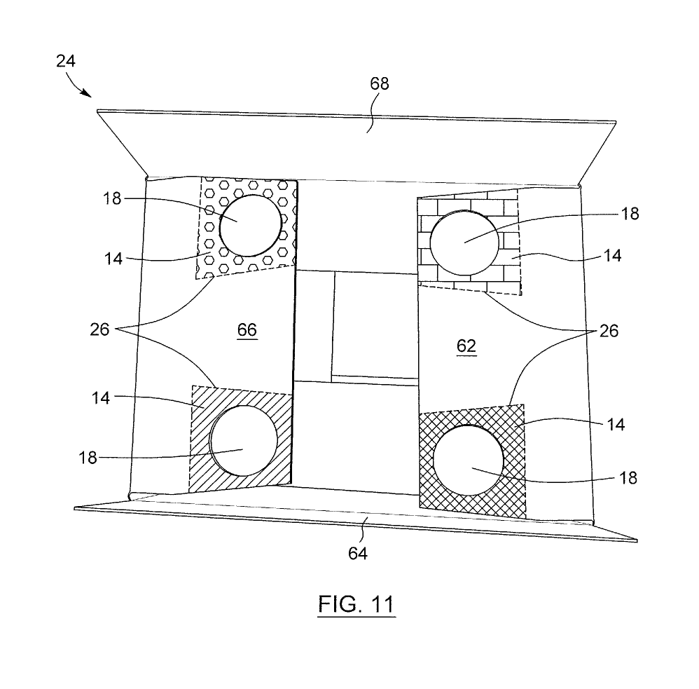

As exemplified in FIG. 11, the consumer-identification markers are visually distinct from one another. For example, each marker (14), has a particular colour, design, sticker, motif, pattern, texture, advertisement, shape, etc. and/or the like.

Alternatively, or additionally, the consumer-identification markers are configured to be personalized with information representing each of the consumers. For example, the consumer-identification markers may each comprise an identification field for writing personalized information representing the given consumer, such as a person's name for example. Preferably, the markers are suitably colored and have a suitable surface to allow easily writing information on the markers. It is to be understood that markers may be visually distinct and still allow personalization by consumers, for example with a substantially light colored design. Yet another example package where markers each have a distinct black and white design, where white areas may be colored or marked for personalization in accordance with the specific consumer. Alternatively, the white areas may be left blank as the designs still allow distinguishing each marker.

The mounting element includes an opening (18) in order to mount the consumer-identification marker (14) about one of the containers (20). According to alternative embodiments, the mounting element is provided by a line of weakness defining a removable an inner portion of the corresponding consumer-identification marker, defining an opening when the inner portion is detached along the line of weakness; and adhesive provided on the consumer-identification marker, i.e. a sticker.

The consumer-identification markers (14) preferably comprise a water resistant material, in order to resist from condensation or other fluids surrounding the container on which it is mounted. For example, the markers (14) may be made of a laminated cardboard. Still preferably, the entire blank (24) is made of this water resistant material, in order to simplify manufacture and to further protect the package from condensation and other fluids.

The blank may be configured, when deployed, to hold the plurality of containers to be marked by the consumer-identification marker, as previously mentioned. According to the embodiment described herein, the package resulting from assembling the package assembly, is shaped and sized to fit twelve beer bottles and is provided with four markers (14). Namely, two markers (14) are provided on each of upper flaps (62, 66). It is to be understood that the package may be shaped and sized according to other standard formats, for example to fit six, eighteen or twenty-four bottles of beer or coolers, as can be understood by a person skilled in the art. Moreover, the number of markers provided on the package, may vary, for example according to the number of containers held in the package, as can also be readily understood by a person skilled in the art. Furthermore, according to alternative embodiments, the package may be formatted and configured to any suitable number of containers and have any suitable number of markers provided thereon.

Still according to an alternative embodiment, with reference to FIG. 12, the package assembly may comprise a container (122) to be filled with the beverage, such as wine, when the blank is deployed, wherein the package assembly further comprises a dispenser (124) being in connected to the container, in order to dispense the beverage into containers (120).

The mounting means comprises a perforation segment (19) which cooperates with the opening (18), thereby defining an open loop when the segment (19) is torn, in order to mount the consumer-identification markers (14) about the container (120) which may be a glass, a wine glass and/or the like (i.e. the marker is C-shaped).

Each of the markers (14) may be detached from the main body (12) (as shown in FIGS. 9 and 10) in order to be placed on a container (20), as depicted in FIG. 2. The markers are located on corners of upper flaps (66 and 62), such that only two of the edges of each marker is connected to the main body (12), by way of the perforation lines (26) to facilitate detaching. Moreover, since the markers are located on the upper flaps (62 and 66), i.e. a non-supporting portion of the package, the box compartment remains intact and can still serve to hold containers.

The containers may be for example beverage containers, such as beer bottles, coolers and/or the like. The container may have a neck and shoulder configuration, i.e. narrow portion (neck) with broader portion (shoulder) thereunder, to allow the marker to sit on the shoulder, such as in the case of a conventional beer bottle or the like. Alternatively, the container may have a conical trunk, which will also allow a marker to sit about this trunk, provided a lower portion of the conical trunk is broader than an upper portion thereof. Still alternatively, the container may be substantially cylindrical, such as a can container. In such a case, the marker must be shaped in tight conformity with the circumference of the cylindrical container, so as to frictionally engage thereabout. Moreover, it is to be understood that the neck portion may be provided at any suitable location or region of the container (i.e. not necessarily an upper portion of the container).

The opening is preferably shaped to fit about the neck of the container. The opening may be circular, oval, etc. or but may also be of any other shape such as triangular, rectangular, etc. so long as it can be supported about the neck of the container. According to an alternate embodiment, the opening is provided by one or more slit, partial slit and/or the like being formed on the marker. For example, a slit on the marker may be widened (which in some cases may further tear the marker, either along a partial slit or beyond the slit or partial slit) and thus provide the opening to be placed about the neck of the container. Preferably, the opening is sized and shaped to conform to the shape of the neck of the container which the main body of the package is made to hold (i.e. if the necks are circular, the opening is circular and shaped to size, or if the opening is a slit, it is sized and configured to conform to the neck when the slit is opened).

According to an alternate embodiment, the opening of the marker may also communicate with the outer periphery of the marker, that is to say, the opening forms an open loop, as exemplified in FIG. 12. Such a configuration allows the marker to be inserted radially about the neck, for example for containers configured such that the marker can not be longitudinally slipped on the container. Such a configuration may also allows the marker to be adjusted to different size containers or different size locations on a given container. The marker may be C-shaped and provided with a fastener (for examples, a hook provided at each extremity of the C-shape), so as to fasten the marker about the neck of the bottle. According to an embodiment, the marker may have a spiral shape. According to another embodiment, the opening may be formed by removing a detachable or partially detachable component (for example, a circular component) which is initially made integral with the marker and separated from the marker by a line of weakness (for example, a line of perforations, a partial slit, etc.). The opening may be further formed by applying pressure on an inner portion of the marker when the marker is placed on the container, for example, the marker may be pierced by thrusting it over the neck of a beer bottle.

Preferably, the marker is positioned on a peripheral edge of the blank, as previously mentioned to facilitate detaching from the main body. As also previously mentioned, the marker is preferably located on a non supporting portion of the main body, in order to preserve the rigidity, strength, etc. required to hold the containers. The main body may thus still hold the containers, even after the markers have been detached from the main body. For example, it may be desirable for the main body to contain empty containers after consumption. It is to be understood however that the marker(s) may be provided at any suitable location on the main body of the package. Moreover, even if one or more markers are located on one of the wall members, or even the floor of the box, etc., the box compartment of the package may still be suitable for holding containers, as can be understood by a person skilled in the art. Moreover, it is to be understood, that the package may be formed of multiple layers of carton, or at the very least, the portion where a marker is located may be multi-layered, such that the marker may be defined on only one of the multiple layers. In such a case, when the marker is detached, the area where the marker was located is still covered with a layer of carton.

According to embodiments, additional markers may be provided between or adjacent the two markers (14) on each flap (62, 66) which are exemplified in the drawings. In the alternative, markers may be provided away from a peripheral edge of the blank. Indeed, one or more markers may be provided at any suitable location of the package. According to an alternative embodiment, the main body is entirely made of detachable markers. Still according to an alternative embodiment, one or more marker (14) may be provided on a handle portion (28) of the box (12).

The package is preferably configured such that the markers are visible when the package is closed (for advertisement, visibility, informative purposes, etc.). Alternatively, the markers may be hidden, for example under upper flaps, also referred to herein as “outer flaps” (64 and 68) when the package is closed, as can also be understood.

According to an alternative embodiment, a set of packages may be provided with integral markers having different combinations of shape and/or color and/or pattern, in order to cater to a large group of users. This may be desirable when a set of packages is required for a same group of people and it is desirable to have a corresponding number of distinct markers.

According to an alternate embodiment, the main body may be have filler disks extending integrally within the markers, each being defined by a perforation line so as to facilitate detaching and thereby provide the corresponding marker with a hole. In other words, the hole in the marker may be created by the user, by pushing out the filler disk.

According to an alternate embodiment, one or more markers are provided with an adhesive, for example they may be peeled off a corresponding area of the package and adhered to the container, for example on the label of a beer bottle. Preferably, the adhesive is water resistant, so as to resist to condensation, water, ice, spilled beverage, and/or any other similar fluent.

Still according to other embodiments, the markers include water resistant, and/or waterproof material, so as to maintain their integrity in the presence of fluid and/or humidity, for example ice and/or water in an icebox, condensation on a bottle, rain, spilled beverage, humidity in the surrounding atmosphere, etc. According to some embodiments, the blank or a portion thereof is made of or comprises said water resistant material. Thus, the blank, package and/or markers may be coated with a water resistant or waterproofing coating.

According to other embodiments, the markers may each be distinguished from the other markers of the same package or set of packages, by other visual elements such as a particular design, sticker, motif, pattern, etc. Alternatively, or additionally, the markers may be tactilely distinct, for example by way of particular textures, embossing, perforations and/or the like. Alternatively, or additionally, the markers may each have a distinct combination of fold lines resulting, when folded, in a three dimensional shape. Alternatively or additionally, the markers have a distinct size, or size of opening (for example, depending on the size of the opening, the marker rests at a different level along the neck of the beer bottle, such that the level at which it rests allows to distinguish each beer bottle).

According to another embodiment, the markers are identical, and preferably of a light color, in order to allow users to personalize their markers as desired (shape, colour, markings, size, etc.). For example, some users may write down their names, initials or the like using a pen or marker. Other users may choose to color their bottle markers. Other users may add a distinct sticker, pin, or the like.

According to other embodiments, the marker may be coated with a latex ink which can be scratched by users for identifying their markers. Alternatively, the marker may be coated with a substance which reacts to water, or the like to provide the marker with a distinct coloration or design.

According to other embodiments, the marker is provided with advertisement.

Still according to an alternate embodiment, the package is designed such that the markers may be cut out, for example, by using scissors, or torn off by the users. In such an embodiment, the openings or portions corresponding to the openings of the markers may be pre-established on the package. Additionally, the shape, color, texture, etc. of the marker may also be pre-established.

The present invention is advantageous in that the package provides markers for the containers packaged therein, thereby eliminating the need to supply markers separately. The markers are disposable so as to avoid concern over losing markers. Moreover, according to some embodiments of the present invention, the markers are located at portions of the box (for example, the upper panels of the box) which are normally no longer useful once the box is opened.

As previously mentioned, the box for packaging the beer bottles may be made of any suitable material, including corrugated containerboard or folding carton.

Numerous modifications could be made to the above-described package with integral markers, without departing from the scope of the present invention. The above-described embodiments are considered in all respect only as illustrative and not restrictive, and the present application is intended to cover any adaptations or variations thereof, as apparent to a person skilled in the art.

1. A method of manufacturing a package assembly for forming a package for a beverage to be consumed from a plurality of containers by a plurality of consumers, the method comprising the steps of:
a) shaping a blank from a web of packaging material;
b) configuring the blank for assembling the blank into the package;
c) providing detachment delimiters in the blank for defining respective consumer-identification markers, each consumer-identification marker being detachable from the blank along the corresponding detachment delimiter; and
d) providing a mounting element on each of the consumer-identification markers of the blank for mounting each of the consumer-identification markers on one of the containers, in order to associate the container with a given one of said plurality of consumers.

2. The method according to claim 1, wherein the web of step (a) comprises cellulose fiber material.

3. The method according to claim 1, wherein the shaping of step (a) comprises die-cutting the web to form the blank.

4. The method according to claim 1, wherein the configuring of step (b) comprises drawing fold lines to define panels which can be folded and assembled into said package.

5. The method according to claim 1, wherein the providing of the detachment delimiters in step (c) comprises perforating the blank along the detachment delimiter of each of the consumer-identification markers.

6. The method according to claim 4, wherein the panels defined at step (b) comprise wall portions to form walls of the package when the wall portions are assembled and deployed, lower flaps extending from the wall portions for forming a floor of the package when assembled with the deployed wall portions in order to give the package a box-shape for holding the beverage, and upper flaps extending from the wall portions opposite the lower flaps to form a cover for the package.

7. The method according to claim 6, wherein the providing of step (c) comprises forming each of the consumer-identification markers substantially on one of the upper flaps.

8. The method according to claim 7, wherein the providing of step (c) comprises forming each of the consumer-identification markers along a peripheral edge of one of the upper flaps.

9. The method according to claim 6, wherein the upper flaps comprise inner flaps which are hidden when the package is closed and outer flaps which cover the inner flaps when the package is closed, and wherein the providing of step (c) comprises forming each of the consumer-identification markers substantially in one of the inner flaps.

10. The method according to claim 1, further comprising printing a field on each consumer-identification marker for receiving at consumption of the beverage, personalization information being representative of an associated one of the consumers.

11. The method according to claim 1, wherein the providing of a mounting element at step (d) comprises at least one of: perforating a loop in an inner portion of each consumer-identification marker to form a removable center; providing an open loop in each consumer-identification marker; cutting an inner portion of the each consumer-identification marker to form an opening; and applying an adhesive on each consumer-identification marker.

12. A package assembly for forming a package for a beverage to be consumed from a plurality of containers by a plurality of consumers, the package assembly comprising:
a blank made from a web of packaging material, the blank comprising one or more assembly component for assembling the blank into said package;
consumer-identification markers being provided in the blank, each being defined by a detachment delimiter in order to detach the consumer-identification marker from the blank along said detachment delimiter; and
a mounting element being provided on each of the consumer-identification markers of the blank for mounting each of the consumer-identification markers on one of the containers, in order to associate the container with a given one of said plurality of consumers.

13. The package assembly according to claim 12, wherein the packaging material comprises a cellulose fiber material.

14. The package assembly according to claim 12, wherein the detachment delimiter is provided by a line of weakness in the blank.

15. The package assembly according to claim 12, wherein the package formed by the blank when deployed defines a supporting portion for supporting the beverage and a non-supporting portion, and wherein the consumer-identification markers are formed in the non-supporting portion.

16. The package assembly according to claim 15, wherein the supporting portion is a box for receiving the beverage and the non-supporting portion is a cover of the box, the blank comprising wall portions delimited by fold lines to form walls of the box and lower flaps extending from the wall portions and being delimited therefrom by fold lines to form a floor of the box, and upper flaps extending from the wall portions opposite the lower flaps, and being delimited from the wall portions by fold lines to form the cover of the box.

17. The package assembly according to claim 16, wherein the consumer-identification markers are located on peripheral edges of the upper flaps.

18. The package assembly according to claim 16, wherein the upper flaps comprise inner flaps which are hidden when the package is closed and outer flaps which cover the inner flaps when the package is closed, and wherein the consumer-identification markers are located substantially on at least one of the inner flaps.

19. The package assembly according to claim 12, wherein the consumer-identification markers are visually distinct from one another.

20. The package assembly according to claim 12, wherein the consumer-identification markers are configured to be personalized with information representing each of the consumers.

21. The package assembly according to claim 12, wherein the consumer-identification markers each comprise an identification field for writing personalized information representing said given one of the consumers.

22. The package assembly according to claim 12, wherein the mounting element is at least one of: an opening provided in the corresponding consumer-identification marker in order to mount the consumer-identification marker about one of the containers; a line of weakness defining a removable an inner portion of the corresponding consumer-identification marker; and adhesive provided on the consumer-identification marker.

23. The package assembly according to claim 12, wherein the blank is configured, when deployed, to hold said plurality of containers.

24. The package assembly according to claim 12, further comprising a container to be filled with the beverage when the blank is deployed, the package assembly further comprising a dispenser being in connected to the container, in order to dispense the beverage into said plurality of containers.

25. The package assembly according to claim 12, wherein the consumer-identification markers are located in a visible portion of the package when the blank is deployed.

26. The package assembly according to claim 12, wherein the consumer-identification markers comprise water resistant material.

27. The package assembly according to claim 12, wherein the blank comprises water resistant material.

28. A package for a beverage to be consumed from a plurality of containers by a plurality of consumers, the package comprising:
a package component being assembled from a blank of packaging material, the package component packaging the beverage;
consumer-identification markers being provided in the package component, each being defined by a detachment delimiter in order to detach the consumer-identification marker from the package component, along said detachment delimiter; and
a mounting element being provided on each of the consumer-identification markers for mounting each of the consumer-identification markers on one of the containers, in order to associate the container with a given one of said plurality of consumers.

29. The package according to claim 28, wherein the package component is adapted to package said beverage containers.

30. The package according to claim 29, wherein the beverage containers comprise at least one of a bottle, a can, a disposable glass.

31. The package according to claim 29, wherein the package component is adapted to package 2 or more beverage containers.

32. The package according to claim 28, wherein the package component is adapted to package 4, 6, 12, 18, or 24 beverage bottles.

33. The package according to claim 28, wherein the package component is adapted to package a recipient filled with the beverage, the package component further comprising a dispenser being in connected to the recipient, in order to dispense the beverage into said plurality of containers.

34. The package according to claim 28, wherein the packaged beverage is at least one of: beer, a cooler beverage, wine, liquor, a cocktail beverage, sparkling wine, champagne, juice, a soft drink, and water.
